(19) United States
(12) Patent Application Publication
(10) Pub. No.: US 2022/0063005 A1
(43) Pub. Date: Mar. 3, 2022

(54) Tool for Double-angle Chamfering Cutter

(71) Applicant: Feilong Auto Components Co., Ltd., Nanyang (CN)

(72) Inventors: Changhong Feng, Nanyang (CN); Han Liu, Nanyang (CN); Bingning Li, Nanyang (CN); Chaofeng Ma, Nanyang (CN); Zebo Ying, Nanyang (CN); Zheng Yuan, Nanyang (CN); Ao Xu, Nanyang (CN); Jianna Li, Nanyang (CN); Shengyang Zhang, Nanyang (CN)

(21) Appl. No.: 17/461,989

(22) Filed: Aug. 30, 2021

(30) Foreign Application Priority Data
Aug. 31, 2020 (CN) 202021856444.2

(51) Int. Cl. B23C 3/12

(52) U.S. Cl. CPC B23C 3/12

(57) ABSTRACT

The present disclosure relates to a tool for a double-angle chamfering cutter, including a cutter handle and a cutter body. The cutter handle is connected to one end of the cutter body via a snap-fit connection device. The cutter body is provided with chamfering blades located symmetrically on both sides of the cutter body. One end of the cutter body is provided with a sliding track perpendicular to the cutter body. A sliding track forms a cavity with the side of the cutter body. A spring is arranged inside the cavity. The bump is fixedly connected to the sliding track. A hole is provided inside the cutter handle. One side of a wall is provided with a groove channel. The cutter body enters along a hole in the cutter handle. The bump corresponding to the cavity of the cutter body falls into the groove channel.

### CROSS REFERENCE TO RELATED APPLICATIONS

The present application claims the benefit of Chinese Patent Application No. 202021856444.2 filed on Aug. 31, 2020, the contents of which are incorporated herein by reference in their entirety.

### TECHNICAL FIELD

The present disclosure relates to a mechanical tool, and more particularly, to a tool of a double-angle chamfering cutter.

### BACKGROUND

In the prior art, if a workpiece with two angles is processed on an aperture element, two chamfering cutters are needed to complete processing alternately. When two chamfering cutters complete a process, the process is relatively cumbersome and the center of an aperture is deviated. During a chamfering process, a plurality of burrs are also difficult to clean. Currently, chamfering at different positions at the same angle by rotating the chamfering cutter at different angles does not provide a chamfering process of different angles.

The Chinese patent publication number CN206854665U disclosed an adjustable chamfering cutter and has an adjustable blade to further complete a chamfering method of different angles. Such a rotation causes the instability of a blade at different degrees. When in use, the cutter is adjusted and fixed with a nut first and then chamfered. Although the number of blades is reduced to a certain extent, there is no process of substantially changing a chamfer.

### SUMMARY

In order to overcome the forgoing drawbacks, an objective of the present disclosure is to provide a tool for a double-angle chamfering cutter with a double-angle chamfering function.

The present disclosure relates to a tool for a double-angle chamfering cutter, including a cutter handle, a cutter body, and a cutter head. The cutter handle is connected to one end of the cutter body via a snap-fit connection device, and the other end of the cutter body is in threaded connection with the cutter head. A cutter box is arranged on the cutter head, and a chamfering blade is arranged on the cutter box.

Preferably, a hole is arranged inside the cutter handle. The diameter of the hole is a half of the diameter of the cutter handle. A groove channel is provided on one side of the hole wall. The cutter body enters along the inner hole of the cutter handle. A bump on the body falls into the groove channel. A aperture is arranged to facilitate the cutter body to enter the cutter handle. The groove channel is arranged to help catch the bump connected to a sliding track of the cutter body, thereby connecting the cutter handle and the cutter body.

Preferably, one end of the cutter body is provided with the sliding track perpendicular to the cutter body. The sliding track and the side of the cutter body form a cavity. A spring is arranged inside. One end of the spring is fixedly connected to the side of the cutter body, and the other end of the spring is fixedly connected to a bump outside the cavity. The bump is fixedly connected to the sliding track. The elasticity and tension of the spring help the bump to expand and contract. The design of the sliding track facilitates the expansion and contraction of the bump along a certain direction and track.

Preferably, the design of a button of a square region on the cutter handle is attached to the groove channel. The middle of the sliding track inside the cutter body is hollow. When the bump falls into the groove channel, the bump can be pressed to the inner side of the cavity of the cutter body by pressing the button. This achieves a good effect of controlling the cutter body by the button.

Preferably, the cutter body is provided with a chamfering blade A and a chamfering blade B at one end away from the cutter handle. The chamfering blade A and the chamfering blade B are connected to the cutter body via a locking screw, respectively. The chamfering blade A and the chamfering blade B are positioned on both sides of the cutter body, respectively. The chamfering blade A and the chamfering blade B are exactly the same two blades.

Preferably, the chamfering blade is provided with two inclined ports in a vertical direction of the cutter body. The upper port is inclined by 30 degrees, and the lower port is inclined by 60 degrees. Two inclined blades are provided on the chamfering blade. Cutting can be performed in two inclined angles via one process. In addition, it can be ensured that center focuses of cutting in two different angles is the same on the same blade.

The present disclosure has the following beneficial effects:

1. The cutter body of the tool for the double-angle chamfering cutter has two chamfering blades on the cutter body. Two chamfering blades are positioned at symmetrical positions, which is convenient to ensure that a cutting angle formed by the corresponding position in the middle of a workpiece is consistent in a process that a double-angle operation is completed, thereby improving the precision of cutting the workpiece.

2. The sliding track is mounted in the cutter body of the tool for the double-angle chamfering cutter. Two ends of the sliding track and three fixing connection points of the spring fix the position of the bump, and further achieves the smoothness of expansion and contraction of the bump at the same time. A rolling bead can be positioned in the sliding track to increase the smoothness of sliding.

3. The chamfering blade of the tool for the double-angle chamfering cutter is provided with two inclined ports with different angles from the vertical direction of the cutter body, which is beneficial to cutting the workpiece at double angles at the same time. The problem of changing the angle of the blades by three to four times is eliminated, thereby saving time and improving process efficiency.

### BRIEF DESCRIPTION OF THE DIAGRAMS

FIG. 1 shows a front view of a tool for a double-angle chamfering cutter.

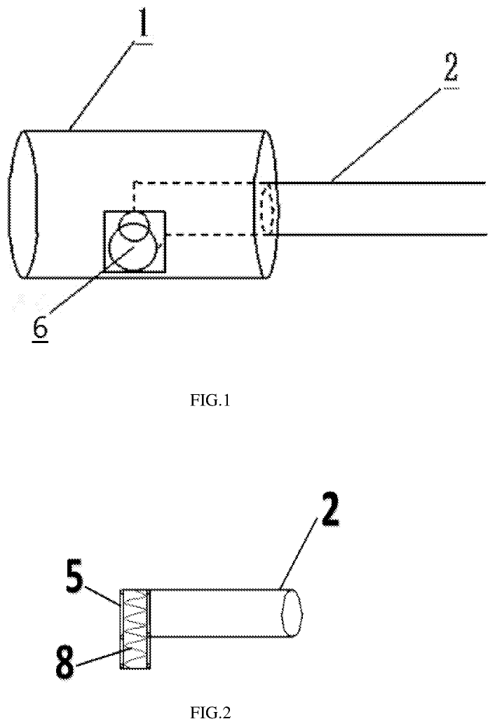

FIG. 2 shows a structural diagram of a double-angle chamfering cutter body.

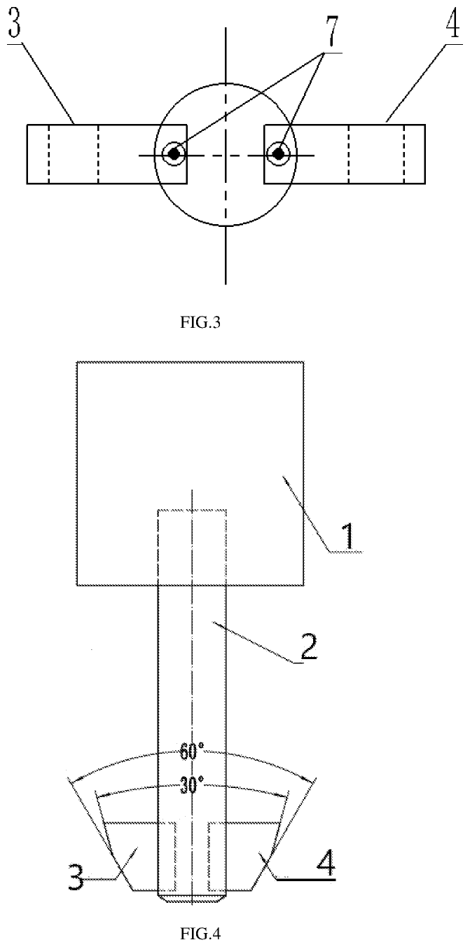

FIG. 3 shows a partial schematic diagram of a structure of a double-angle chamfering blade.

FIG. 4 shows a cross-sectional diagram of a tool for a double-angle chamfering cutter.

1—Cutter handle, 2—Cutter body, 3—Chamfering blade A, 4—Chamfering blade B, 5—Sliding track, 6—Button, 7—Locking screw, 8—Spring

### DESCRIPTION OF THE INVENTION

The technical solutions in embodiments of the present disclosure are described clearly and completely below in conjunction with the drawings in the embodiments of the present disclosure. Obviously, the described embodiments are only a part of the embodiments of the present disclosure, rather than all the embodiments. Based on the embodiments of the present disclosure, all other embodiments obtained by the person skilled in the art without creative labor shall fall within the protection scope of the present disclosure.

### Embodiment 1

As shown in FIG. 1, there is provided a tool for a double-angle chamfering cutter, including a cutter handle 1 and a cutter body 2. The cutter handle 1 is connected to the cutter body 2 via a snap-fit device. FIG. 2 shows a partial schematic diagram of a cutter body 2 clamped into the cutter handle 1. One end of the cutter body 2 is provided with a sliding track 5 perpendicular to the cutter body. The sliding rail 5 and the side of the cutter body 2 form a cavity. A spring 8 is arranged inside the cavity. One end of the spring 8 is fixedly connected to the side of the cutter body 2, and the other end of the spring 8 is fixedly connected to a bump outside the cavity. The bump is fixedly connected to the sliding track 5. One aperture is provided inside the cutter handle 1. One side of the aperture is provided with a groove channel. The cutter body 2 enters along of the aperture inside the cutter handle 1. The bump on the cutter body 2 falls into the groove channel. The outer part of the cutter handle 1 has a square region. The square region is provided with one button 6. The inner part of the button 6 is connected to the top of the bump. When the cutter body 2 enters the cutter handle 1, the bump falls into the groove channel, and the cutter handle 1 and the cutter body 2 can be fixed. FIG. 3 shows a partial schematic diagram of a structure of a double-angle chamfering blade. FIG. 4 shows a cross-sectional diagram of a tool for a double-angle chamfering cutter. The end of the cutter body away from the cutter handle is provided with a chamfering blade A 3 and a chamfering blade B 4. The chamfering blade A 3 and the chamfering blade B 4 are at the corresponding positions on both sides of the cutter body 2. The chamfering blade A 3 and the chamfering blade B 4 are at 180 degrees. The chamfering blade A 3 and the chamfering blade B 4 are connected to the cutter body 2 via a locking screw 7, respectively. Two inclined ports are both provided on the chamfering blade A 3 and the chamfering blade B 4. An upper port forms an included angle of 30 degrees with the cutter body 2 in a vertical direction. The lower port forms an included angle of 60 degrees with the cutter body in a vertical direction.

### Embodiment 2

This embodiment is distinct from Embodiment 1 in that a chamfering blade A and a chamfering blade B of this embodiment are fixed to a cutter body by welding, respectively. The chambering blade A and the chamfer blade B can be fixed and are not easily loosen by the welding, which is more beneficial to the fixation of the blade. The blade is not easy to move during a plurality of operations. However, inconvenience is that the surface of the blade body is easily damaged when the blade is replaced, and a process of removing the blade is complicated.

### Embodiment 3

As shown in FIG. 3, a partial schematic diagram of a structure of a cutter body, this structure is a part of a cutter body that is clamped into a cutter handle. Embodiment 3 is distinct from Embodiment 1 in that a sliding track contains a folded sliding sheet instead of a rolling bead. The sliding sheet is fixedly connected to a bump. In the process of sliding, the expansion and contraction of the folded sliding sheet drives the bump to contract and expand. The stretchability of the sliding sheet is relatively good. The expected expansion and contraction effects can be achieved at the same time. The flexibility and the smoothness of the rolling bead are better than those of the sliding sheet. The best components can be selected according to the current price during a selection process.

Finally, it should be noted that the forgoing embodiments are only used to illustrate the technical solutions of the present disclosure and are not to limit thereto. Other modifications or equivalent substitutions made by the person skilled in the art to the technical solutions of the present disclosure shall fall in the scope of claims of the present disclosure without departing from the spirit and scope of the present disclosure.

What is claimed is:

1. A tool for a double-angle chamfering cutter, comprising a cutter handle and a cutter body, wherein the cutter handle is connected to one end of the cutter body via a snap-fit connection device, and the other end of the cutter body is provided with a chamfering blade, and the chamfering blade is positioned symmetrically on both sides of the cutter body.

2. The tool for the double-angle chamfering cutter according to claim 1, wherein the inner side of the cutter handle is provided with a hole, a diameter of the hole is a half of a diameter of the cutter handle, one side of a hole wall is provided with a groove channel, and the cutter body enters along the hole inside the cutter handle.

3. The tool for the double-angle chamfering cutter according to claim 1, wherein one end of the cutter body is provided with a sliding track perpendicular to the cutter body, the sliding track and the side of the cutter body form a cavity, a spring is arranged inside, one end of the spring is fixedly connected to the side of the cutter body, and the other end of the spring is fixedly connected to a bump outside the cavity, and the bump is fixedly connected to the sliding track.

4. The tool for the double-angle chamfering cutter according to claim 1, wherein the snap-fit connection device comprises a groove channel on the handle and the bump facing the cavity, and the bump follows the cutter body to enter the cutter handle along the hole and falls into the groove channel inside the cutter handle.

5. The tool for the double-angle chamfering cutter according to claim 1, wherein the cutter body is provided with two chamfering blades at one end away from the cutter handle, the chamfering blade is engaged with the cutter body via a locking screw, two chamfering blades are a chamfering blade A and a chamfering blade B, respectively, the chamfering blade A and chamfering blade B are positioned on both sides of the cutter body, and the chamfering blade A and the chamfering blade B are two identical blades.

6. The tool for the double-angle chamfering cutter according to claim 5, wherein the chamfering blade A and the chamfering blade B are both provided with two inclining ports in a direction perpendicular to the cutter body, an upper port is inclined by 30 degree, and the lower port is inclined by 60 degrees.

7. The tool for the double-angle chamfering cutter according to claim 1, wherein a square region is provided on the cutter handle, a button is arranged in the square region, the button is attached to the groove channel, and the square region is positioned in a middle of a diameter of the cutter handle.
